(19) United States
(12) Patent Application Publication
(10) Pub. No.: US 2026/0079774 A1
(43) Pub. Date: Mar. 19, 2026

(54) METHOD AND SYSTEM FOR CAPABILITY REGISTRATION AND QUERYING

(71) Applicant: AT&T Intellectual Property I, L.P., Atlanta, GA (US)

(72) Inventors: Sean Simon, Lynnwood, WA (US); Aman Deep Singh Gill, Mill Creek, WA (US); Ananya Gurrala, Bothell, WA (US)

(73) Assignee: AT&T Intellectual Property I, L.P., Atlanta, GA (US)

(21) Appl. No.: 18/885,966

(22) Filed: Sep. 16, 2024

(51) Int. Cl. G06F 9/54; G06F 16/22; G06F 16/23; G06F 16/953

(52) U.S. Cl. CPC G06F 9/547; G06F 16/22; G06F 16/2379; G06F 16/953

(57) ABSTRACT

Aspects of the subject disclosure may include, for example, receiving, via an API and from a first element, information relating to the first element, storing the information in a registration database, resulting in stored information, after the storing, receiving, via the API and from a second element, a query requesting information regarding the first element, wherein the first element and the second element comprise functions that are communicatively coupled to one another over a network, retrieving the stored information responsive to the query, resulting in retrieved information, and providing, via the API, the retrieved information to the second element, thereby facilitating interactions between the second element and the first element. Other embodiments are disclosed.

### BACKGROUND

Information technology and mobility core domains typically contain many elements that facilitate signaling or support functions, and thus can be quite complex. Elements or functions may have dissimilar capacities, performance, technologies, interfaces, and engineering limits that generally need to be coordinated in order to achieve end-to-end service establishment and delivery. With the automation to continuous delivery and continuous integration, a software-defined platform's composition can change as well, which can make such coordination challenging. Systems today deploy as independent elements, and the coordinating functions for alignment of engineering rules or supplemental information are done essentially as best effort. In addition, there are typically no application programming interface (API) discovery methods available to obtain such critical information from tenant applications for sharing between systems. This problem becomes exponentially more pronounced in environments that involve more systems and system releases. As an example, a network function, such as a User Plane Function (UPF), can have four or five different deployments with different generations of technology, virtual machine sizes, compute footprints, processor types, network connectivities, and/or impacting characteristics. Systems can also be transitory. For instance, the amount of capacity that a system allocates may change depending on the time of day, cost, workload, and/or other factors. Overall, management of the exchange of information characteristics between populations of systems is generally challenging, complicated, and time-sensitive.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communications network of FIG. 1 in accordance with various aspects described herein.

FIG. 2B illustrates a process flow for capability registration and querying in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a capability registration server that is capable of functioning as a centralized repository where systems can register and supply informational elements relating to (e.g., that are critical to) their platform's operations. In one or more embodiments, the capability registration server may be configured with an API that allows systems to provide key performance, capacity, and/or system-level details as well as query for such information, in real-time or near real-time. In some embodiments, the capability registration server may support the enumeration of registered elements and their associated data elements (e.g., in leaf, branch, and/or spine form for future reference and tracking). In various embodiments, the capability registration server may provide a query interface via an API that allows a real-time (or near real-time) state of a system or environment to be obtained. As an example, one or more embodiments of the capability registration server can be implemented in a mobility infrastructure—i.e., as a mobile core capability registration server (MCCRS). In these embodiments, the MCCRS may enable systems or functions, such as, for instance, management functions, to register as they are deployed via software pipelines and to supply the MCCRS with system-level characteristics (e.g., name, software release, interfaces, etc.) and/or performance or capacity characteristics (e.g., interface transactions per second (TPS), subscriber capacity, throughput, etc.). Systems that are upstream or downstream of a given management function, for instance, may subscribe to, obtain, and evaluate load factors or sizing information associated with the management function. In various embodiments, the capability registration server can serve as a needed inventory or discovery function for a given newly-arriving system, which may query the capability registration server for the current inventory of systems or specific entities that are contributors to the newly-arriving system's own integration.

In one or more embodiments, the capability registration server can grant a unique instance identifier (ID) to a system so as to facilitate subscriptions to and/or querying for the information regarding that system. A given subscriber can thus “follow” specific characteristics or values of registered element(s) that affect that subscriber. In some embodiments, as systems are updated or changed through cloud functions, such as auto-scaling, the capability registration server can allow registered information to be revised. In this way, registered elements may be referenced by a unique ID, allowing their changes or updates to be tracked by other stakeholder systems.

In certain embodiments, the capability registration server can allow systems that are being added, moved, or changed through orchestration within the cloud to de-register to ensure proper state. In one or more embodiments, the capability registration server may (e.g., periodically or based on one or more conditions being satisfied) poll the registered systems to ensure an accurate state for their characteristics.

By providing a robust system for registering and querying system characteristics, the capability registration server enables dynamic and automated management of elements and thus efficient system operations. Embodiments of the capability registration server described herein advantageously reduce the coordination that would otherwise be required for information sharing between systems or functions within a network. For instance, the capability registration server overcomes the limitations of the Network Registration Function (NRF) that has been implemented by the 3rd Generation Partnership Project (3GPP) for mobility functions, by enabling sharing of information regarding key Fault, Configuration, Accounting, Performance, or Security (FCAPS) functions. In the case of the NRF, network elements generally only provide a name and certain attributes relating to their role in the network infrastructure so that the network can identify the mere presence of particular elements. However, there may be engineering rules or other information—e.g., information regarding signaling, upstream capacity, downstream capacity, load factors, etc.—about a network element (which may not necessarily relate to that element's particular role in the network infrastructure) that would be useful for adjacent systems or pairwise systems to be made aware of, especially if there are changes to the network element that can affect the operations of those systems. In various embodiments, the capability registration server can introduce a self-reporting function for (e.g., all) network elements/systems that can be utilized via APIs, which enables the problem of differences in characteristics based on compute resources, generations in technology, release levels, or other factors that influence FCAPS, key performance indicators (KPIs), or key capacity indicators (KCIs) to be easily addressed or resolved. The capability registration server can also expose other critical functions such as topology, APIs of the registered systems/functions, inventory information, and/or any other useful information. In one or more embodiments, a uniform resource locator (URL) of the capability registration server can be provided to platforms using a custom option in the Dynamic Host Configuration Protocol (DHCP) configuration, which allows platforms to automatically know where to register and discover information when they obtain their network configuration from the DHCP server.

As mobility infrastructure and systems migrate to cloud or hyper-scale technologies, the network environment becomes more abstract and complex to manage. Workloads and functions in the cloud become transient or elastic based on business needs, making it increasingly difficult to manage capacities, performance, or system-level characteristics. The capability registration server advantageously provides a basis for populating system-level implementation, performance, capacity, or topology-level details into a common repository that can be queried via an API. This allows for real-time (or near real-time) delivery of capacity or system-level characteristics and thus constitutes a significant evolution over existing methods. This approach eliminates the need to coordinate the discovery and ingestion of parameters (as was otherwise necessary in prior generations of technology), which streamlines operations and enhances efficiency.

While the capability registration server is generally described herein in the context of mobile core networks, it will be understood and appreciated that the capability registration server can extend beyond mobile core usage, and thus can provide a versatile solution for a variety of network environments.

One or more aspects of the subject disclosure include a device, comprising a processing system, and a memory storing instructions that, when executed by the processing system, cause the processing system to perform operations. The operations can include receiving, via an application programming interface (API) and from a first element, information relating to the first element. The operations can further include storing the information in a registration database, resulting in stored information. The operations can further include after the storing, receiving, via the API and from a second element, a query requesting information regarding the first element, wherein the first element and the second element comprise functions that are communicatively coupled to one another over a network. The operations can further include retrieving the stored information responsive to the query, resulting in retrieved information. The operations can further include providing, via the API, the retrieved information to the second element, thereby facilitating interactions between the second element and the first element.

One or more aspects of the subject disclosure include a method. The method can include determining, by a processing system of a first element that includes a processor, that an action is to be performed relating to a second element, wherein the first element and the second element comprise functions deployed over a network. The method can further include responsive to the determining, submitting, by the processing system, a query to a capability registration server for information regarding the second element, wherein the second element has previously registered the information with the capability registration server, and wherein the information comprises data regarding capabilities, performance, characteristics, or a combination thereof of the second element. The method can further include based on the submitting, obtaining, by the processing system, the information from the capability registration server. The method can further include utilizing, by the processing system, the information to facilitate performing of the action.

One or more aspects of the subject disclosure include a non-transitory machine-readable medium, comprising executable instructions that, when executed by a processing system including a processor, facilitate performance of operations. The operations can include receiving, via an application programming interface (API) and from a first element, information relating to the first element. The operations can further include storing the information in a registration database, resulting in stored information. The operations can further include after the storing, receiving, via the API and from a second element, a query requesting information regarding the first element, wherein the first element and the second element comprise functions that are deployed across a network. The operations can further include obtaining the stored information responsive to the query, resulting in obtained information. The operations can further include providing, via the API, the obtained information to the second element, thereby facilitating interactions between the second element and the first element.

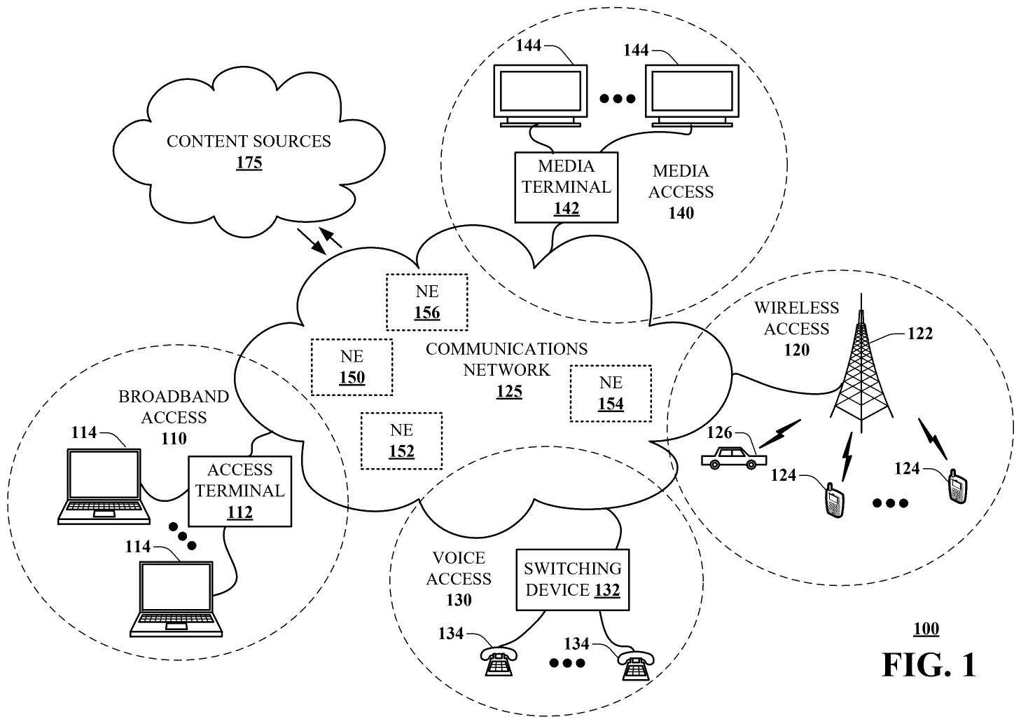

Referring now to FIG. 1, a block diagram is shown illustrating an example, non-limiting embodiment of a system 100 in accordance with various aspects described herein. For example, system 100 can facilitate, in whole or in part, capability registration and querying. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

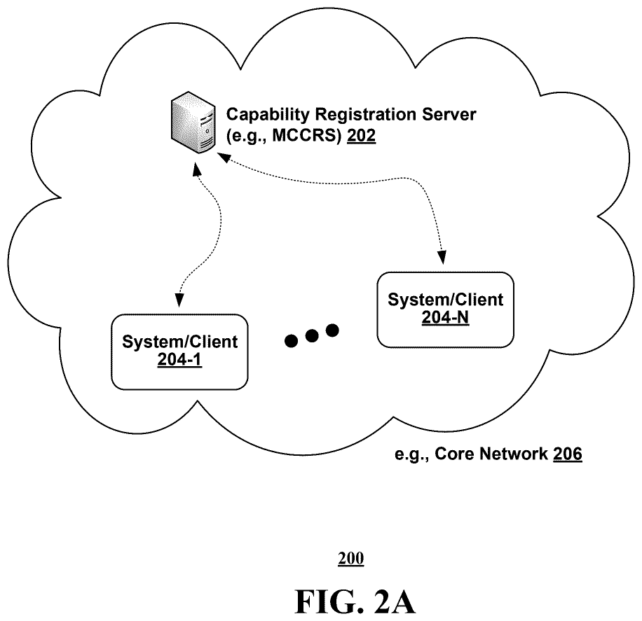

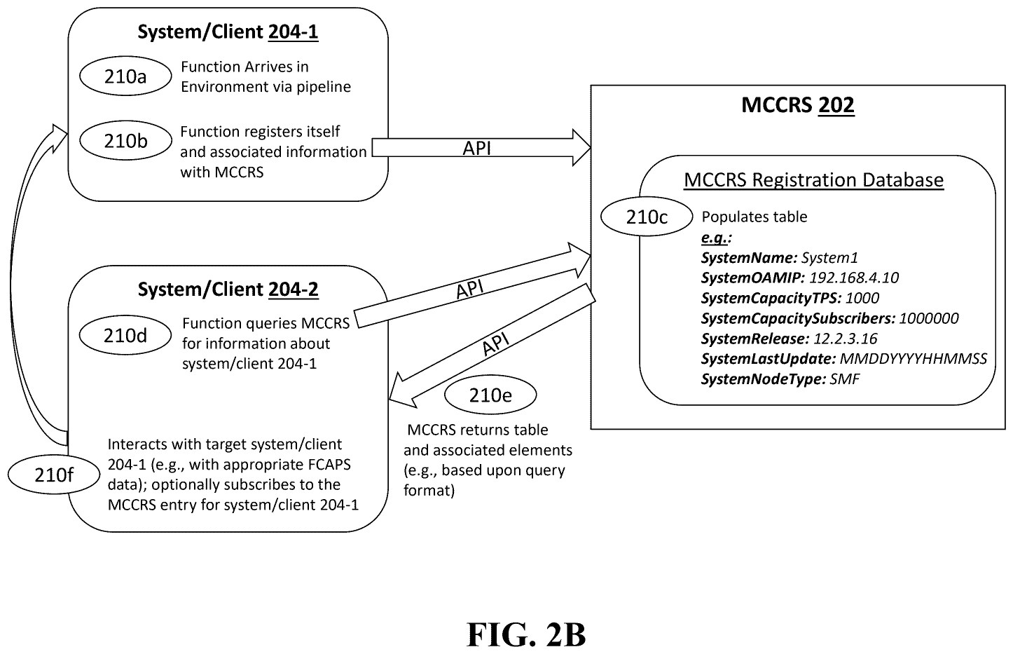

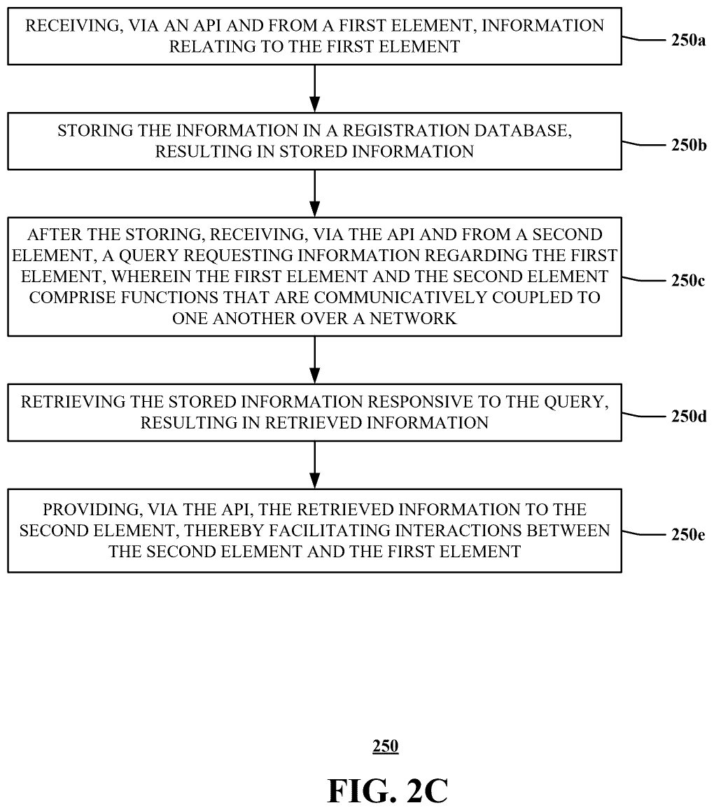

FIG. 2A illustrates an example environment 200 for facilitating system capability registration and querying. The environment 200 may include a capability registration server 202 (e.g., an MCCRS) and one or more systems/clients 204-1 through 204-N (N≥1) (hereinafter referred to collectively as “systems/clients 204,” and individually as “system/client 204” or by specific designation [e.g., system/client 204-1, 204-2, 204-3, etc.]). In exemplary embodiments, the MCCRS 202 and the systems/clients 204 may reside, or may be included, in a core network 206 (e.g., a mobile core network, such as a 5G core, a 6G core, or a higher generation technology core).

The systems/clients 204 may include one or more computing devices that are capable of interacting with each other and/or the MCCRS 202. In exemplary embodiments, the systems/clients 204 may include various network functions and elements that facilitate the operation and management of the core network 206. These may include data plane functions (e.g., a UPF and/or the like), control plane functions (e.g., a Session Management Function (SMF), an Access and Mobility Management Function (AMF), and/or the like), policy and charging functions (e.g., a Policy Control Function (PCF) and/or the like), and/or other core network functions that interact to facilitate network operations/services.

The MCCRS 202 may include one or more computing devices that are capable of managing and performing operations relating to the registration and querying of system/client capabilities and/or characteristics. The MCCRS 202 may have access to and manage various data structures, such as databases, arrays, linked lists, tables, trees, and/or the like to store and organize the registered information. In various embodiments, the MCCRS 202 may be configured to facilitate consolidation of engineering rules across systems/clients 204 while allowing for API exposure of key functions relating to those systems/clients 204. The MCCRS 202 may be configured with one or more APIs that the systems/clients 204 can utilize to interact with the MCCRS 202. A system/client 204 may register information with the MCCRS 202, such as that regarding its capabilities (e.g., performance metrics, capacity details, system-level characteristics, and/or the like). In one or more embodiments, some or all of the information regarding a given system/client 204 may have been included in a management manifest that is packaged with a software that implements the system/client when deployed—e.g., the same as or similar to that described in U.S. patent application Ser. No. 17/872,051 filed on Jul. 25, 2022 and entitled “CLOUD DEPLOYMENT OF NETWORK FUNCTION SOFTWARE WITH A MANAGEMENT MANIFEST” (now U.S. Patent No. 12,028,424), which is incorporated by reference herein in its entirety. In these embodiments, the system/client 204 may provide some or all of such management manifest information (or perhaps provide the management manifest itself) to the MCCRS 202 as part of its registration therewith. In any case, such registration allows the MCCRS 202 to maintain a centralized repository of information that can be queried by (e.g., any) system/client 204 for real-time (or near real-time) retrieval of target system capabilities and characteristics.

FIG. 2B illustrates a process flow for capability registration and querying in accordance with various aspects described herein. At step 210a, a function relating to the system/client 204-1 may arrive or be initiated or instantiated in an environment, such as the environment 200 of FIG. 2A. For instance, the function may arrive as part of a function deployment or update pipeline. At step 210b, the function may register itself and its associated information with the MCCRS 202. For instance, the system/client 204-1 may provide information regarding its capabilities and/or characteristics to the MCCRS 202 via an API. This information may include, for example, the name of the system (e.g., SystemName), the system's Operations, Administration, and Maintenance IP address (e.g., SystemOAMIP), the system's capacity in terms of transactions per second (e.g., SystemCapacityTPS), the system's capacity in terms of subscribers (e.g., SystemCapacitySubscribers), the system's software release version (e.g., SystemRelease), the last update timestamp of the system (e.g., SystemLastUpdate), the type of system node (e.g., SystemNodeType), and/or the like. In one or more embodiments, the information may include FCAPS data, such as fault data (e.g., information about current/historical faults or errors), configuration data (e.g., details about the system's configuration, such as network settings, software and hardware configurations, interface configurations, and any custom settings or parameters), accounting data (e.g., data on how much bandwidth, processing resources, or memory resources that the system is using, usage data and metrics, such as resource consumption, transaction counts, and/or billing information, etc.), performance data (e.g., metrics relating to the system's latency, throughput, response times, and/or system load, which can include KPIs and KCIs), and/or security data (e.g., authentication and authorization details, security policies, encryption methods, and/or any security incidents or breaches).

At step 210c, the MCCRS 202 (e.g., a processor thereof) may populate the registration database with the received information. At step 210d, the system/client 204-2 may submit a query, via the API, to the MCCRS 202 for information regarding the system/client 204-1. For instance, the system/client 204-2 may have a need to interact with the system/client 204-1 (e.g., provide data thereto and/or receive data therefrom), and may query the MCCRS 202 for the information so as to determine the compatibility, capacity, and/or current state of the system/client 204-1. In one or more embodiments, the query may be formatted in accordance with a particular format (e.g., which may be specified by the MCCRS 202) so as to ensure that the requested information is accurately retrieved. At step 210e, MCCRS 202 may return, to the system/client 204-02, some or all of the requested information. At step 210f, the system/client 204-2 may interact with the target system/client 204 based on the obtained information. For instance, the system/client 204-2 may analyze the obtained information to identify or otherwise understand the capabilities and characteristics of the system/client 204-1, which the system/client 204-2 can utilize to interact or establish a connection with the system/client 204-1. Such interaction may, for instance, be in accordance with the appropriate FCAPS data—e.g., not sending particular type(s) of traffic due to faults experienced by the system/client 204-1 when handling such type(s) of traffic. In one or more embodiments, the system/client 204-2 may (e.g., optionally) subscribe to the MCCRS entry for the system/client 204-1 (i.e., the information therefor in the above-described registration database) so as to receive ongoing updates relating to the system/client 204-1. In this way, the MCCRS 202 can ensure accurate, up-to-date recording of system capabilities and characteristics and enable efficient querying and retrieval of this information to facilitate interactions between systems in the network.

As an example use case of the MCCRS capability, consider a data center that provides capacity via systems/clients 204, such as UPFs, to facilitate network connectivity for subscribers. The data center may, for instance, have a cumulative total capacity of 1 million subscribers or 1 terabyte of data, where the different UPFs may have varying capacities based on different generations of technology. As UPFs are deployed or decommissioned, it might be useful to track the number of concurrently deployed UPFs up to the 1 million subscriber limit. Each time a UPF arrives on the network, the UPF may register itself with the MCCRS 202 by supplying its capacity and other relevant information. The MCCRS 202 can ensure that the total capacity does not exceed 1 million subscribers by allowing the UPFs to query for the total capacity of one another. In some embodiments, the MCCRS 202 can aggregate the capacities of all registered UPFs, and provide this aggregated information in response to queries, which can inform the UPFs on capacity constraints of not only the UPF that has been queried about but also of the overall network. In various embodiments, the MCCRS 202 can coordinate with the UPFs to perform the tally and/or automatically update the total available capacity as new UPFs register or existing UPFs are decommissioned. In any case, by facilitating registration of the current state and capacity of each UPF, the MCCRS 202 can provide a means of engineering for determining whether the 1 million subscriber limit is being exceeded. This capability addresses a common problem in signaling within a mobility network, where one network function (NF) typically has to signal to multiple other NF elements. The MCCRS 202 allows NFs to be made aware of upstream and downstream signaling capacities and constraints. Overall, this can be thought of as a capability that is the sum of its parts—provided by way of individual NFs registering their own capacities, performance, characteristics, etc. and querying about one another's metrics—that allows for a comprehensive end-to-end view of the total signaling capability across the network. In some embodiments, the MCCRS 202 may build a specific composition of the available capacity of one or more UPFs and/or aggregate the capacity data provided by the registered UPFs. This composition can be continuously or periodically updated to reflect the current state of the network. The MCCRS 202 can compare capacities against one or more predefined thresholds, such as the 1 million subscriber limit or a limit of a given UPF's capacity. For instance, in one example, the MCCRS 202 can compare the capacity of a given UPF against a predefined threshold specific to that UPF. If the capacity of the given UPF is equal to or exceeds this threshold, the MCCRS 202 can issue alarms or notifications to one or more UPFs that are anticipated to send traffic to the overloaded UPF. These anticipations can be based on historical data, such as past traffic patterns, or based on prior queries that those UPFs have previously submitted to the MCCRS 202. For instance, the MCCRS 202 can maintain a historical log of traffic patterns and query submissions from various UPFs. By analyzing this historical data, the MCCRS 202 can predict which UPFs are likely to send traffic to a particular UPF that is nearing its capacity limit. The MCCRS 202 can then proactively notify these UPFs so as to allow them to adjust their traffic routing or take other measures to prevent overloading the target UPF. This proactive approach advantageously helps maintain network stability and ensures that individual and overall capacity limits are not exceeded. In various embodiments, the MCCRS 202 can provide detailed information in the alarm(s) or notification(s), such as the current capacity utilization, the specific threshold that has been exceeded, and/or recommendations for mitigating the overload. This enables the UPFs to make informed decisions and take appropriate actions to manage their traffic and capacity effectively. In another example, the MCCRS 202 can compare the total aggregated capacity of all UPFs against a global threshold, such as the 1 million subscriber limit. If the total aggregated capacity is equal to or exceeds this threshold, the MCCRS 202 can similarly issue alarm(s) or notification(s) to one or more UPFs that are anticipated to contribute to the overload. Again, such anticipations can also be based on historical data or prior queries submitted to the MCCRS 202. In any case, the MCCRS 202 ensures that capacity limits are not exceeded, thereby maintaining network stability and performance.

In exemplary embodiments, the API of the MCCRS 202 may enable elements (systems/clients/devices) to self-register and advertise their system attributes, KPIs, and/or characteristics for efficient cloud placement and resource management. In one or more embodiments, the API may be configured to support discovery operations that enable dynamic and automated management of elements. In various embodiments, the API may be configured with security and authentication features. Secure registration may be implemented using Open Authorization (OAuth) or similar protocols, and API keys may be used for subsequent authentications. Communications may be encrypted using Hypertext Transfer Protocol Secure (HTTPS) to ensure data security. In various embodiments, the API may be implemented based on a flexible and extensible data model that accommodates a wide range of device types and attributes. For instance, aspects of the Simple Network Management Protocol (SNMP) Object Identifier (OID) hierarchy for standard attributes and KPIs may be mirrored. That is, in various embodiments, implementation of the API may mirror SNMP's ability to deliver inventory and KPI discovery by using a structured hierarchy that is similar to that of SNMP. In these embodiments, groups of informational elements or counters may be grouped together for the purpose of bulk discovery and/or updates or may be grouped together to communicate an association between elements. Mirroring aspects of the SNMP OID hierarchy for standard attributes and KPIs may involve adopting a structured and hierarchical approach to organizing and managing data within the API. For instance, the API may assign unique identifiers to each system/client/device, and group together various attributes, such as device ID, manufacturer, model, software version, and operational status. This hierarchical structure allows for efficient querying and management of device inventory, which enables bulk discovery and updates of device attributes. Additionally, the API may organize and manage performance metrics and KPIs in a similar manner by grouping related metrics, such as CPU usage, memory usage, network throughput, and error rates under common identifiers. By adopting this structured approach, the API can efficiently manage and query performance metrics, facilitating dynamic and automated management of elements. This mirroring of the SNMP OID hierarchy can ensure that the API delivers inventory and KPI discovery in a manner that is both efficient and scalable. In some embodiments, a hierarchical data structure that provides for ease of navigation and consistency may be used. In exemplary embodiments, the API endpoint may be designed in accordance with Representational State Transfer (RESTful) principles. In one or more embodiments, version control may be incorporated for the API to manage changes and ensure backward compatibility. The API may be configured with hierarchical endpoint structures for supporting discovery-like functionalities. For instance, the API may implement hierarchical endpoint structures for traversal. The API may also implement query parameters for filtering. In certain embodiments, the API may utilize pagination and batching for data management, allowing for bulk operations or wildcards for broad queries. In various embodiments, the API may include metadata and hyperlinks in API responses for guided navigation. In one or more embodiments, the API may support real-time (or near real-time) updates or subscriptions for dynamic monitoring. In some embodiments, the API may be configured to support monitoring for usage and performance and provide management capabilities for administrators.

In various embodiments, the data model hierarchy may include basic element information (e.g., ID, type (such as SMF, UPF, etc.), manufacturer, model, software release, etc.), network information (e.g., Internet Protocol (IP) and media access control (MAC) addresses, connected network, etc.), system attributes (e.g., processor availability/usage, memory availability/usage, pod layouts, container orchestration system details, package manager chart versions or repositories, configuration version, last configuration change data, etc.), system performance or capacity (e.g., KCIs, engineering limits, such as interface TPS, simultaneous attached users (SAU), etc.), defined points of measure for performance (e.g., network latency, packet loss, throughput, etc.), cloud placement attributes (e.g., resource requirements, preferred cloud provider, deployment region, etc., some or all of which may be inherited from package manager template details and/or orchestration service template details), and/or custom attributes (e.g., flexible schema for additional element-specific attributes, etc.). In some embodiments, the API may or may not continuously publish or provide real-time updates of KPIs. For instance, the API may define specific targets or points where KPIs can be obtained when needed. This allows the API to serve as a reference or directory for locating system-level KPIs rather than being a primary source of real-time (or near real-time) KPI data. In other words, the API can provide information about where and how to access the relevant KPIs, such as network latency, packet loss, throughput, and/or error rate, without constantly streaming this data, thus managing the performance data efficiently without overwhelming a subscriber system/client with continuous real-time (or near real-time) data updates.

In exemplary embodiments, the MCCRS 202 may be configured for scalability and reliability—i.e., with a server infrastructure that is scalable and that can handle high loads. A scalable database solution may be used, and fault tolerance mechanisms may be implemented to ensure continuous operation. The MCCRS 202 may process registrations and updates in real-time (or near real-time), using the registered information for automating cloud resource allocation. In various embodiments, the MCCRS 202 may be configured with mechanisms for ensuring data privacy and compliance with relevant regulations and standards.

In many networks, devices are allocated addresses in accordance with a standards-based protocol such as DHCP. In one or more embodiments, a URL of the MCCRS 202 can be provided to platforms using a custom option in a DHCP configuration. This custom option can be embedded in a DHCP server (not shown)—e.g., by a network administrator that configures the DHCP server to include the URL of the MCCRS 202 in a DHCP options field. When a platform, such as a system/client 204, requests an IP address from the DHCP server, the DHCP server can respond with an IP address along with the custom DHCP option containing the URL of the MCCRS 202. This allows platforms to automatically determine where to register and discover information when they obtain their network configuration from the DHCP server. For instance, the system/client 204 can then use the URL to connect to the MCCRS 202 and register the system/client 204's attributes, characteristics, and other relevant data therewith. In various embodiments, a given system/client 204 may be configured (e.g., programmed) to look for and extract the URL from the DHCP options field, and use the extracted URL to establish a connection with the MCCRS 202. The URL may, for instance, point to an API endpoint of the MCCRS 202 that allows the system/client 204 to communicate directly with the MCCRS 202 via the API. Once connected, the system/client 204 can initiate the registration process by transmitting its attributes, characteristics, etc. to the MCCRS 202 via the API.

In certain alternative embodiments, the MCCRS 202 may or may not require systems to register their information in advance. In these embodiments, for instance, when a system/client 204-2 queries the MCCRS 202 for information about system/client 204-1, the MCCRS 202 can dynamically request the necessary information from system/client 204-1. Upon receiving the requested information from system/client 204-1, the MCCRS 202 can then provide this information to system/client 204-2. This approach allows the MCCRS 202 to facilitate interactions between systems/clients 204 without necessitating prior registration, thereby offering a more flexible and on-demand information retrieval mechanism.

In certain example implementations, the MCCRS 202 may be configured to perform adaptive monitoring of registered system/client characteristics or performance data. For instance, the MCCRS 202 may, based on received informational elements for a system/client 204, perform an analysis relating to the received data. As an example, the MCCRS 202 may compare the received data with historical data to determine whether a difference between the received data and the historical data (e.g., differences in TPS metrics, differences in KPIs, differences in network latency, etc.) is less than a predetermined threshold. Where the MCCRS 202 determines that the difference between the received data and the historical data is not less than the predetermined threshold, the MCCRS 202 may obtain additional data from the system/client 204. This additional data may relate to the status of the system/client 204, such as temperature, error logs, troubleshooting logs, and/or the like associated with that system/client 204. The MCCRS 202 may analyze this additional data to identify potential factors that may have led to the above-threshold differences, which can inform the MCCRS 202 on particular adjustments that can be made for the system/client 204 (e.g., updating software in the system/client 204, adjusting resource allocation, etc.). The MCCRS 202 may then provide commands regarding such adjustments to the system/client 204 and/or its management system for implementation. In this way, the MCCRS 202 may limit its collection of additional data relating to systems/clients 204 to when the initially received data reflects a poor or abnormal condition. This reduces excess requests for data, which avoids excess traffic volume over the network that could otherwise negatively impact network performance. If the MCCRS 202 determines that the abnormal condition is no longer present (i.e., threshold is no longer being exceed), the MCCRS 202 can cease the collection of additional data from the system/client 204, thereby further optimizing network performance and reducing unnecessary data traffic. The additional data can be used to analyze the cause of the poor or abnormal condition, thereby providing an improvement over existing system management methods, resulting in a practical application that improves network/device performance monitoring.

It is to be understood and appreciated that, although one or more of FIGS. 2A and 2B might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, clients, servers, networks, devices, etc. may have been illustrated in one or more of FIGS. 2A and 2B as separate systems, clients, servers, networks, devices, etc., it will be appreciated that multiple systems, clients, servers, networks, devices, etc. can be implemented as a single system, client, server, network, device, etc., or a single system, client, server, network, device, etc. can be implemented as multiple systems, clients, servers, networks, devices, etc. Additionally, functions described as being performed by one system, client, server, network, device, etc. may be performed by multiple systems, clients, servers, networks, devices, etc., or functions described as being performed by multiple systems, clients, servers, networks, devices, etc. may be performed by a single system, client, server, network, device, etc.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

FIG. 2C depicts an illustrative embodiment of a method 250 in accordance with various aspects described herein. In some embodiments, one or more process blocks of FIG. 2C can be performed by a capability registration server, such as the MCCRS 202.

At 250a, the method can include receiving, via an API and from a first element, information relating to the first element. For example, the MCCRS 202 can, similar to that described above with respect to FIGS. 2A and/or 2B, perform one or more operations that include receiving, via an API and from a first element, information relating to the first element.

At 250b, the method can include storing the information in a registration database, resulting in stored information. For example, the MCCRS 202 can, similar to that described above with respect to FIGS. 2A and/or 2B, perform one or more operations that include storing the information in a registration database, resulting in stored information.

At 250c, the method can include after the storing, receiving, via the API and from a second element, a query requesting information regarding the first element, wherein the first element and the second element comprise functions that are communicatively coupled to one another over a network. For example, the MCCRS 202 can, similar to that described above with respect to FIGS. 2A and/or 2B, perform one or more operations that include after the storing, receiving, via the API and from a second element, a query requesting information regarding the first element, wherein the first element and the second element comprise functions that are communicatively coupled to one another over a network.

At 250d, the method can include retrieving the stored information responsive to the query, resulting in retrieved information. For example, the MCCRS 202 can, similar to that described above with respect to FIGS. 2A and/or 2B, perform one or more operations that include retrieving the stored information responsive to the query, resulting in retrieved information.

At 250e, the method can include providing, via the API, the retrieved information to the second element, thereby facilitating interactions between the second element and the first element. For example, the MCCRS 202 can, similar to that described above with respect to FIGS. 2A and/or 2B, perform one or more operations that include providing, via the API, the retrieved information to the second element, thereby facilitating interactions between the second element and the first element.

In one or more embodiments, the information relating to the first element can include fault data, configuration data, accounting data, performance data, security data, or a combination thereof.

In one or more embodiments, the information relating to the first element can include data relating to KPIs, KCIs, TPS metrics, network latency, packet loss, throughput, error rate, subscriber capacity, or a combination thereof.

In one or more embodiments, the network can include a mobile core network.

In one or more embodiments, the functions can include a user plane function, a control plane function, an access management function, a mobility management function, a policy function, a charging function, or a combination thereof.

In one or more embodiments, the providing the retrieved information to the second element can enable the second element to evaluate characteristics associated with, or a current state of, the first element.

In one or more embodiments, the operations can further include assigning a unique instance identifier (ID) to the first element, and associating the unique instance ID with the stored information. In these embodiments, the query can identify the unique instance ID. Further, in these embodiments, the retrieving can involve a lookup operation using the unique instance ID.

In one or more embodiments, the one or more operations can further include polling, via the API, the first element to provide updated information relating to the first element, and based upon receiving the updated information, storing the updated information in the registration database for the first element.

In one or more embodiments, the operations can further include receiving, via the API and from the second element, a request to subscribe to an entry in the registration database for the first element, detecting an update to the stored information relating the first element, and based on the detecting, causing, via the API, updated information relating to the first element to be provided to the second element.

In one or more embodiments, the first element can be a first deployed instance of a particular function, and a third element can be another deployed instance of the particular function. In these embodiments, the operations can further include receiving, via the API and from the third element, information relating to the third element, storing the information relating to the third element in the registration database, receiving, via the API and from the second element, another query requesting the information regarding the third element, responsive to the another query, retrieving the information relating to the third element, and providing, via the API, the information relating to the third element to the second element, thereby facilitating interactions between the second element and the third element.

In one or more embodiments, the one or more operations can further include receiving, via the API, a de-registration request from the first element, wherein the de registration request is based on a change to the first element that is effected via cloud orchestration, and responsive to the de-registration request, deleting or archiving the stored information relating to the first element.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

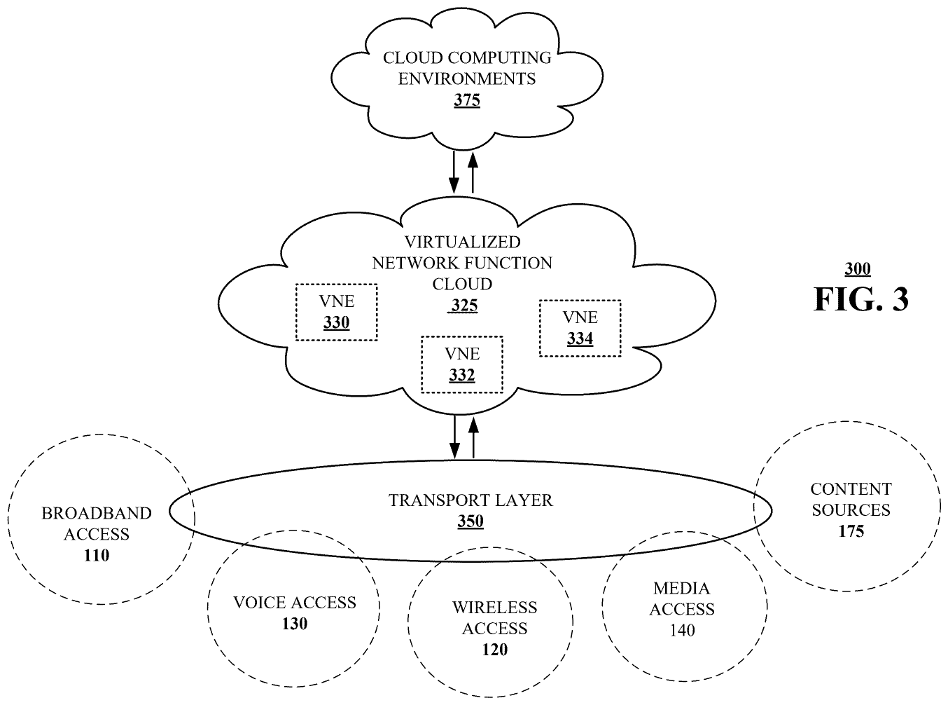

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and method 250 presented in FIGS. 1, 2A, 2B, and 2C. For example, virtualized communications network 300 can facilitate, in whole or in part, capability registration and querying.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers - each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

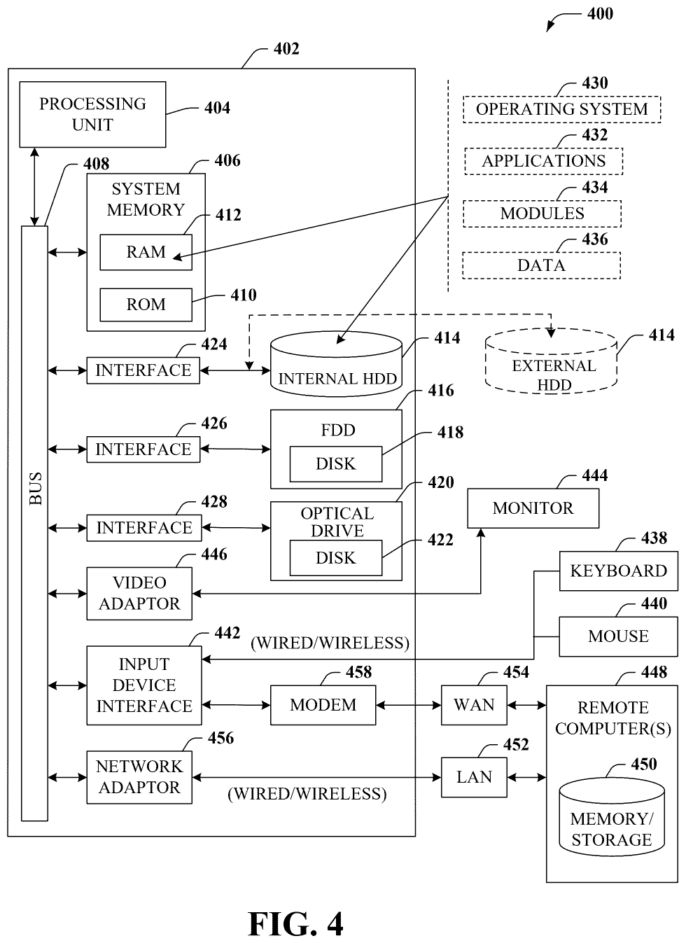

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, capability registration and querying.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

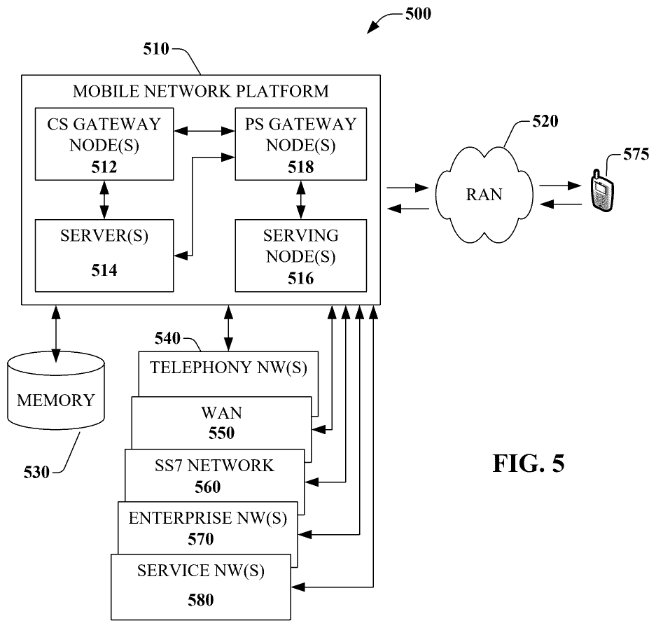

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, capability registration and querying. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

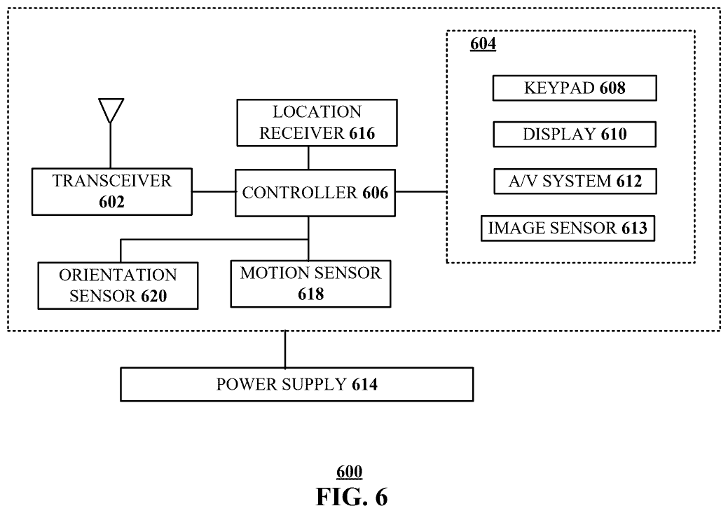

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, capability registration and querying.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth®and ZigBee®are trademarks registered by the Bluetooth®Special Interest Group and the ZigBee®Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data “storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or. ” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system; and
a memory storing instructions that, when executed by the processing system, cause the processing system to perform operations that include:
receiving, via an application programming interface (API) and from a first element, information relating to the first element;
storing the information in a registration database, resulting in stored information;
after the storing, receiving, via the API and from a second element, a query requesting information regarding the first element, wherein the first element and the second element comprise functions that are communicatively coupled to one another over a network;
retrieving the stored information responsive to the query, resulting in retrieved information; and
providing, via the API, the retrieved information to the second element, thereby facilitating interactions between the second element and the first element.

2. The device of claim 1, wherein the information relating to the first element includes fault data, configuration data, accounting data, performance data, security data, or a combination thereof.

3. The device of claim 1, wherein the information relating to the first element includes data relating to key performance indicators (KPIs), key capacity indicators (KCIs), transaction per second (TPS) metrics, network latency, packet loss, throughput, error rate, subscriber capacity, or a combination thereof.

4. The device of claim 1, wherein the network comprises a mobile core network.

5. The device of claim 1, wherein the functions comprise a user plane function, a control plane function, an access management function, a mobility management function, a policy function, a charging function, or a combination thereof.

6. The device of claim 1, wherein the providing the retrieved information to the second element enables the second element to evaluate characteristics associated with, or a current state of, the first element.

7. The device of claim 1, wherein the operations further include:
assigning a unique instance identifier (ID) to the first element; and
associating the unique instance ID with the stored information.

8. The device of claim 7, wherein the query identifies the unique instance ID.

9. The device of claim 8, wherein the retrieving involves a lookup operation using the unique instance ID.

10. The device of claim 1, wherein the one or more operations further include:
polling, via the API, the first element to provide updated information relating to the first element; and
based upon receiving the updated information, storing the updated information in the registration database for the first element.

11. The device of claim 1, wherein the operations further include:
receiving, via the API and from the second element, a request to subscribe to an entry in the registration database for the first element;
detecting an update to the stored information relating the first element; and
based on the detecting, causing, via the API, updated information relating to the first element to be provided to the second element.

12. The device of claim 1, wherein the first element is a first deployed instance of a particular function, and wherein a third element is another deployed instance of the particular function.

13. The device of claim 12, wherein the operations further include:
receiving, via the API and from the third element, information relating to the third element;
storing the information relating to the third element in the registration database;
receiving, via the API and from the second element, another query requesting the information regarding the third element;
responsive to the another query, retrieving the information relating to the third element; and
providing, via the API, the information relating to the third element to the second element, thereby facilitating interactions between the second element and the third element.

14. The device of claim 1, wherein the one or more operations further include:
receiving, via the API, a de-registration request from the first element, wherein the de-registration request is based on a change to the first element that is effected via cloud orchestration; and
responsive to the de-registration request, deleting or archiving the stored information relating to the first element.

15. A method, comprising:
determining, by a processing system of a first element that includes a processor, that an action is to be performed relating to a second element, wherein the first element and the second element comprise functions deployed over a network;
responsive to the determining, submitting, by the processing system, a query to a capability registration server for information regarding the second element, wherein the second element has previously registered the information with the capability registration server, and wherein the information comprises data regarding capabilities, performance, characteristics, or a combination thereof of the second element;
based on the submitting, obtaining, by the processing system, the information from the capability registration server; and
utilizing, by the processing system, the information to facilitate performing of the action.

16. The method of claim 15, wherein the action comprises sending traffic from the first element to the second element.

17. The method of claim 15, wherein the submitting comprises submitting the query to an application programming interface (API) endpoint of the capability registration server.

18. The method of claim 17, further comprising:
obtaining, by the processing system, and as part of a Dynamic Host Configuration Protocol (DHCP) process in which an Internet Protocol (IP) address is allocated for the first element, a uniform resource locator (URL) that is associated with the API endpoint of the capability registration server, wherein the submitting is based on the obtaining the URL.

19. A non-transitory machine-readable medium, comprising executable instructions that, when executed by a processing system including a processor, facilitate performance of operations, the operations comprising:
receiving, via an application programming interface (API) and from a first element, information relating to the first element;
storing the information in a registration database, resulting in stored information;
after the storing, receiving, via the API and from a second element, a query requesting information regarding the first element, wherein the first element and the second element comprise functions that are deployed across a network;
obtaining the stored information responsive to the query, resulting in obtained information; and
providing, via the API, the obtained information to the second element, thereby facilitating interactions between the second element and the first element.

20. The non-transitory machine-readable medium of claim 19, wherein the information relating to the first element includes data relating to key performance indicators (KPIs), key capacity indicators (KCIs), transaction per second (TPS) metrics, network latency, packet loss, throughput, error rate, subscriber capacity, or a combination thereof.
